(19) United States
(12) Patent Application Publication
(10) Pub. No.: US 2011/0282641 A1
(43) Pub. Date: Nov. 17, 2011

(54) METHOD AND SYSTEM FOR REAL-TIME PARTICLE SIMULATION

(76) Inventors: Stefan Bobby Jacob Xenos, Stittsville (CA); Benjamin Barrie Houston, Ottawa (CA)

(21) Appl. No.: 13/108,095

(22) Filed: May 16, 2011

Related U.S. Application Data
(60) Provisional application No. 61/345,137, filed on May 16, 2010.

(51) Int. Cl. G06F 9/455

(52) U.S. Cl. 703/19

(57) ABSTRACT

A method and system for particle simulation are provided in which the number of particles is held as close as possible below a prescribed particle limit. When adding new particles to the simulation results in approaches the particle limit, new particles which contribute most to the visual quality of the simulation are added first, followed by deleting or merging existing particles which contribute least before adding the remaining new particles. Visual quality is also optimized by splitting particles into two or more new particles until the target particle count is reached. The criteria for performing insertions, deletions, splitting, or merging are governed by the results of predefined fitness functions by which the visual effect of each operation is estimated.

### RELATED APPLICATIONS

The present application claims benefit from the U.S. provisional application Ser. No. 61/345,137 filed on May 16, 2010 for “Method and System for Real-Time Particle Simulation”, entire contents of which are incorporated herein by reference.

### FIELD OF THE INVENTION

The present invention relates generally to systems and methods of particle simulation, and in particular to a method and system for real-time particle simulation.

### BACKGROUND OF THE INVENTION

Fluids are a subset of the joint phases of matter (including liquids, gases, plasmas and to some extent plastic solids) which constantly deform while under an applied shear stress. Fluids may be differentiated from solids by observing that relative positions of elements of the fluid change greatly when small forces are applied, whereas constituent elements of solid materials tend to remain in the same place relative to one another. A more comprehensive treatment of fluids can be found in Batchelor, G. K. (2000), An Introduction to Fluid Dynamics. Cambridge University Press.

Fluid Dynamics (FD) is a branch of physics devoted to the mathematical modelling of fluid behaviour, with applications in diverse fields such as aviation, computer graphics, and medication design. Historically, FD has been used mainly to develop models for mechanical engineering applications, but in the past 30 years significant progress has been made on applying FD to other areas of study.

Computational Fluid Dynamics (CFD) exists as a body of ongoing research into efficient methods of simulating complex FD systems. Since it is often either impossible or prohibitively time-consuming to derive exact solutions to FD problems, it is necessary to approximate these solutions using computer simulations. Advancements in this field have allowed progressively more accurate approximations to be achieved.

There have been a number of diverse simulation methods presented in CFD literature, some of the most prevalent of which include Eulerian (grid-based) and Lagrangian (particle-based) simulations, and various schemes which combine elements of the two (e.g. semi-Lagrangian). Each technique possesses certain strengths and drawbacks, and is applicable to a subset of CFD problems; generally, most Eulerian simulations provide increased accuracy at the expense of computational resources, while most Lagrangian simulations provide fast simulation at the expense of accuracy.

Particle systems are a common, broadly applicable technique in physical simulation and computer graphics, whereby a complex effect can be approximated by a collection of particles (N-dimensional points, with appropriate associated metadata) animated by a collection of forces (e.g. gravity, magnetic attraction or repulsion, wind). Some particles may have geometry attached, or some other shape representing their boundary (e.g. elliptical particles, geometry sprites). The number of elements in a particle simulation is not necessarily fixed; new particles can be introduced, and existing particles can be removed.

Within the category of Lagrangian fluid simulations, several distinct subcategories exist.

Smoothed Particle Hydrodynamics (SPH) is such a method, treating all particles within a simulation as parcels of fluid and applying forces to these particles to directly modify the velocity field of the fluid. This implies that every feature of the velocity field needs to be embodied within the set of SPH particles.

In the context of fluid simulation, a field is an algebraic structure which defines some function or value over a three dimensional space. The velocity of a fluid can thus be conceptualized as a field defined over the volume of the fluid, the value of which at any given point represents the immediate velocity of the field at that point. Regardless of the simulation method chosen, this concept holds for FD simulations.

In contrast to SPH, vortex method simulations treat a number of Lagrangian elements as features of the fluid's vorticity field, which describes a turbulence of the fluid, and is dual to its velocity field; from this vorticity field we can reconstruct the velocity of the fluid. Since a turbulent fluid can be represented by a small number of basic vorticity primitives, whereas a velocity field may require a large amount of data to fully express that same state, vortex methods are often able to encode more information about the fluid's velocity than SPH, using fewer particles. Further discussion of vortex methods can be found in a chapter on Hybrid Particle Methods in R. Bridson, Fluid Simulation for Computer Graphics (pp. 137-154). A. K. Peters, Ltd.

Accordingly, there is a need in the industry for the development of a simple yet efficient method and system for real-time particle simulation, which would avoid or mitigate disadvantages of the prior art.

### SUMMARY OF THE INVENTION

There is an object of the present invention to provide an improved method and system for particle simulation.

According to one aspect of the invention, there is provided a method, performed by a processor, for simulating a scene containing particles in a particle set, the particles representing visual elements of the scene, the method comprising:

(a) determining and continuously updating a particle count of particles in the particle set;
(b) determining respective fitness values for particle count reducing operations, comprising deleting operations and merging operations, correspondingly deleting and merging existing particles in the particle set, the fitness value of each particle count reducing operation being indicative of an incremental impact of the operation on a visual quality of the scene;
(c) determining fitness values for particle count increasing operations, comprising inserting operations and splitting operations, correspondingly inserting new particles into the particle set and splitting selected existing particles into groups of two or more particles;
(d) performing particle count increasing operations, including inserting the new particles into the particle set provided the particle count remains below a predefined limit, according to the fitness values of the corresponding particle count increasing operations so as to improve the visual quality of the scene.

The method further comprises:

(e) provided the particle count has reached the predefined limit and there are available new particles:
(e1) performing an additional particle count increasing operation, including inserting a new particle into the particle set, the particle being selected according to the fitness value of the particle count increasing operation;
(e2) performing a particle count reducing operation, including deleting an existing particle or merging selected existing particles, the particles being selected according to the fitness values of the particle count reducing operation;
(e3) repeating the steps (e1) and (e2) until there are no more new particles.

In the method described above, in the step (e1) the particle count increasing operations are performed in an order of their respective fitness values, and in the step (e2) the particle count reducing operations are performed in an opposite order, wherein the order is one of the following: from higher fitness values to lower fitness values; or from lower fitness values to higher fitness values.

The method described above further comprises:

(f) maximising the visual quality of the scene, comprising:
(f1) performing a particle count reducing operation, including deleting an existing particle or merging selected existing particles, the particle being selected according to the fitness value of the particle count reducing operation;
(f2) performing a particle count increasing operation, including splitting an existing particle, the particle being selected according to the fitness value of the particle count increasing operation;
(f3) repeating the steps (f1) and (f2) as long as the visual quality of the scene is improved.

In the step (f1), the particle count increasing operations are performed in an order of their respective fitness values, and in the step (f2) the particle count reducing operations are performed in an opposite order; and wherein the order is one of the following: from higher fitness values to lower fitness values; or from lower fitness values to higher fitness values.

In the method described above, the step (c) comprises:
generating a delete record for each delete operation, comprising a reference to one of the existing particles and a fitness value of the delete operation; and
generating a merge record for each merge operation, comprising a reference to a respective merge candidate particle and corresponding merge target particle and a fitness value of the merge operation.

In the method described above, the step (d) comprises:
generating an insert record for each insert operation, comprising a reference to a new particle and a fitness value of the insert operation; and
generating a split record for each split operation, comprising a reference to an existing particle from the particle set and a fitness value of the split operation.

In the embodiments of the invention:
the step of generating further comprises queuing the insert records in an insertions queue; and
the step of inserting the new particles comprises reading insert records from the insertions queue in the order of respective fitness values.

In the method described above, the steps (a) to (d) are performed every k-th video frame, k>=1.

In the method described above, the merging comprises:
selecting pairs of neighbouring particles and identifying particles of each selected pair as merge candidate and merge target particles;
generating a merge record for each selected pair, each merge record comprising a reference to the merge candidate and the merge target of the respective selected pair, and the fitness value of the merge operation; and
storing each merge record in a merge cache.

The step of generating further comprises queuing the delete records in a deletions queue; and the method further comprises obtaining selected merge records and storing them into the deletions queue.

In the method of the embodiments of the invention, the fitness values for the particle count increasing or reducing operations depend on geometric volume or screen area, density and an aspect ratio of particles involved in the operation and resulting from the operation.

For example, the fitness value for the split operation is a function of a largest and smallest dimension of the particle to be split.

Alternatively, the fitness value for the split operation is a difference between combined fitness values of two or more insert operations of particles resulting from the split, and the fitness value of the delete operation for deleting a particle to be split; and the fitness value for the merge operation is a difference between the fitness value of the insertion operation for a particle resulting from the merge and combined fitness values of two or more deletion operations of particles being merged.

In the method described above, the particles are ellipsoid particles. Alternatively, the particles are vortex particles.

According to another aspect of the invention, there is provided a system for real-time particle simulation, comprising a general purpose or specialized processor and a computer readable storage medium having computer readable instructions for execution by the processor, forming:
a current particles module for storing a set of particles;
a pruning setup module for generating particle operation records to specify one or more of inserting, deleting, splitting and merging particles in the current particles module;
a fitness evaluator module for assigning, for each particle involved in one or more of inserting, deleting, splitting and merging operations, respective visual fitness values for each operation, and storing the assigned visual fitness values in the particle operation records;
two or more of particle operations queues for storing the particle operation records including their respective visual fitness values; and
a pruning operations module for retrieving the particle operation records from the particle operations queues in an order of their respective visual fitness values, and executing on the set of particles each particle operation indicated in the retrieved particle operation records.

The system further comprises a particles additions module for temporarily storing new particles injected into the simulation, the particles additions module being operatively coupled to the pruning setup module.

The system further comprises a particle counter for tracking the number of particles in the current particles module.

The system further comprises:
a particle neighbours module for determining nearest neighbours of particles in the set of particles;
a merge selection module for identifying, from the particle neighbours module, particles as merge candidates and merge targets; and
a merge cache for storing the merge candidates and merge targets, to be available to the pruning setup module.

In the system described above, the set of particle operations queues comprises an insertions queue for storing particle operation records which have an effect of increasing the number of particles, including insert records and split records, and a deletions queue for storing particle operation records which have an effect of decreasing the number of particles, including delete records and merge records.

According to yet another aspect of the invention, there is provided a method, performed by a processor, for real-time simulation of a scene containing particles in a particle set, representing visual elements of the scene, the method comprising:
reducing a particle count in the particle count reducing operation by deleting or merging selected existing particles in the particle set;
increasing the particle count in a particle count increasing operation by inserting new particles into the particle set or by splitting selected existing particles;
assigning a fitness value indicative of an impact on a visual quality of the scene to each of the particle count reducing operation and the particle count increasing operation; and
provided the fitness value assigned to an increasing operation is higher than the fitness value assigned to a reducing operation, performing the particle count increasing operation and the particle count reducing operation so that the total particle count is not increased and the visual quality of the scene is improved.

Thus, an improved real-time particle simulator and method have been provided.

### BRIEF DESCRIPTION OF THE DRAWINGS

Embodiments of the invention will now be described, by way of example, with reference to the accompanying drawings, in which:

FIG. 1 shows a Computer Platform 100 for running simulations according to embodiments of the invention;

FIG. 2 shows a block diagram of a Real-time Particle Simulator System 200 according to an embodiment of the invention that may be implemented on the Computer Platform 100 of FIG. 1;

FIG. 3 shows examples of a format 300 of operations records for storage in the Particle Operations Queues 212 of FIG. 2;

FIG. 4 illustrates an example of a splitting operation 400 according to an embodiment of the invention, showing shows a stretched 3-dimensional (3D) ellipsoid smoke particle 402, and a pair of smaller ellipsoid smoke particles 404 and 406 resulting from splitting the particle 402;

FIG. 5 shows a symbolic representation of a vortex particle 500;

FIG. 6 is a simplified flow chart 600 of the method of operation of the Simulator System 200 of FIG. 2;

FIG. 7 is a more detailed flow chart of the “Pruning Phase” 608 step of FIG. 6;

FIG. 8 is a more detailed flow chart of the step “Add Remaining New Particles” 716 of FIG. 7;

FIG. 9 is a more detailed flow chart of the step “Maximize Quality” 720 of FIG. 7; and

FIG. 10 is a more detailed flow chart of the “Merge Selection” step 612 of FIG. 6.

### DESCRIPTION OF THE EMBODIMENTS OF THE INVENTION

Embodiments of the present invention provide various methods of particle simulation, while bounding the memory and required processing resources. These methods can be applied to a wide variety of fields, in which particle systems are in common usage, such as computer animation, video game development, and physical simulation, just to name a few.

The present invention is concerned with the efficiency of dealing with a number of particles in a particle simulation in terms of their quantity and their impact on visual quality. The number of particles in a particle system simulation greatly affects the runtime and memory usage of the simulation. A type of simulation of interest here proceeds in simulation steps where each simulation step may typically correspond to a frame, or video frame, of a video display system when the simulation is rendered and may be displayed in real time.

At each simulation step, runtime and memory usage of the simulation as well as visual quality of the simulation, may be controlled by managing the number of particles in the simulation.

The number of particles may be increased naturally when new particles are added by particle emitters of the simulation. The number of particles may be managed by splitting existing particles when the number of particles is low, and by removing existing particles or by merging existing particles when the number of particles is higher than a programmable limit Pmax. The limit Pmax is specified by the application depending on the resources it is willing to dedicate to the particle simulation system. The limit Pmax is provided prior to the each given frame of the simulation, and can be changed by the application arbitrarily from frame to frame. It is, however, assumed to remain constant throughout a single frame time-step.

The visual quality of the simulation may be affected when the particle count is managed in this way. It is an objective of the present invention to choose particles for operations such as insertion, deletion, splitting, or merging in such a way that visual quality is improved while the total number of particles is held at, or below, the predefined limit Pmax.

The criteria for performing insertions or removals are governed by the results of visual fitness functions, which will be simply referred to as “fitness functions”. A fitness function returns a visual fitness value indicating whether a given operation would improve or degrade the quality of the simulation in terms of a visual quality of a scene containing particles, and by what degree. One convention would be to make the result of any fitness function positive if the given operation would improve the visual quality of the scene and negative if it would make it worse, with the magnitude of the result representing the degree to which the visual quality of the scene is affected.

By pairing particle insertions with removals, a particle count of the simulation can be maintained. These actions may be executed in an optimization phase if the result of their combined fitness functions gives a sum greater than some prescribed cut-off value which may be zero. In this way the quality of the simulation is increased or at least maintained, while its memory and computational requirements are kept bounded.

The visual and computational quality of the simulation may also be affected by making use of fading, warping and other similar techniques when executing insertions or removals. Such transitions are designed to help mitigate unrealistic effects in both the simulation and its rendered output, which may otherwise be caused by methods of the embodiment of the present invention. Fading and warping may be implemented differently for different types of particles, and are designed to spread the effects of insertions and removals over several simulation frames.

The embodiments of the present invention also provide an optimized strategy for selecting particles to merge from the simulation. For each particle for which merging could be beneficial, the proposed method selects another particle nearby and merges the two particles, after determining that combining the two would not have a significant adverse effect on simulation quality. Because finding the exact nearest neighbour for every such particle may be computationally expensive, this step could be performed every few frames instead of every frame without a noticeable loss in simulation quality. Alternatively a fast nearest neighbour approximation algorithm could be used. This step could also benefit from the application of randomized algorithms. A complete discussion of approximation algorithms (pages 1022-1056), randomization (pages 91-122), and nearest neighbour searches (pages 957-965), may be found in: Cormen, T. H., Leiserson, C. E., Rivest, R. L., & Stein, C. (2009); Introduction to Algorithms (Third Edition); The MIT Press.

It is also possible to make use of particle “classes”, members of which are disallowed from merging with particles in other classes. Furthermore, the simulation may be divided into “batches” of particles of the same class for the purpose of staggering the updating process over multiple frames. The concept of classes allows several independent partial simulations to proceed without unrealistic side-effects, e.g., a smoke particle merging with a water particle. The concept of batches allows the execution time of certain operations in each frame to be reduced without significant visual impact. Both techniques simplify resource management by keeping the combined cost of the complete simulation below a bound.

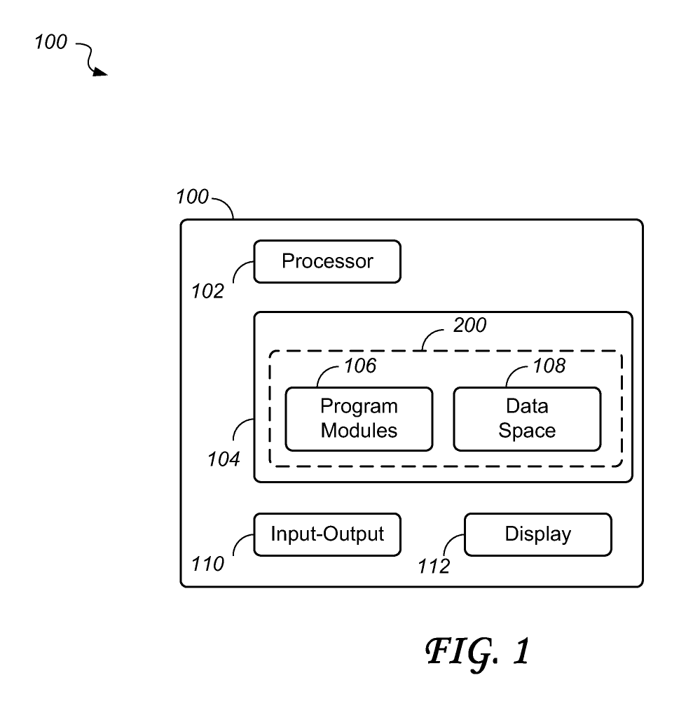

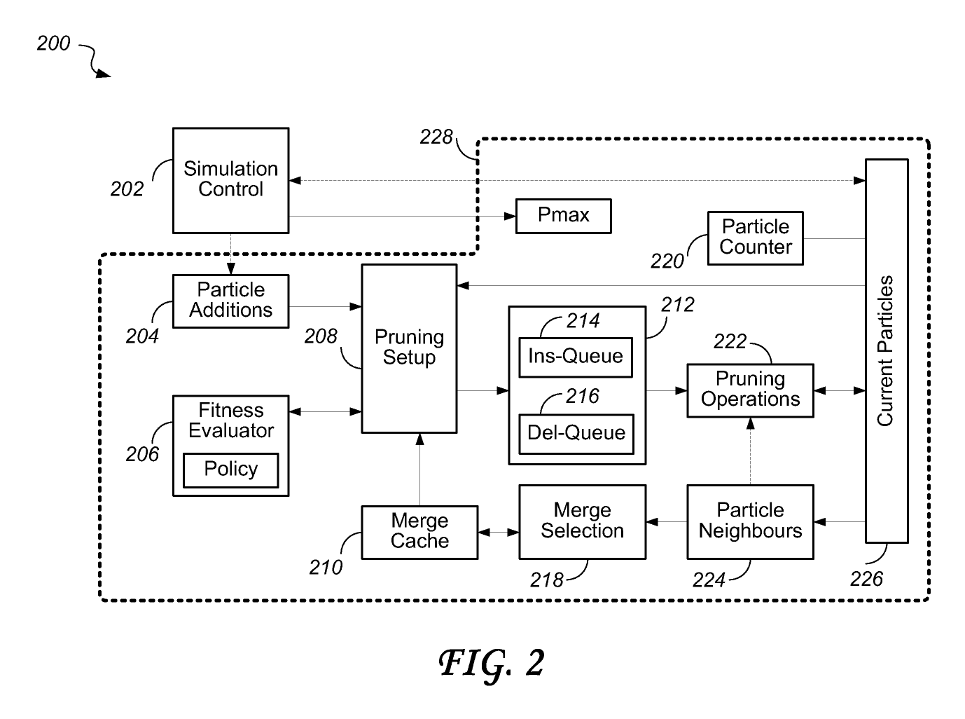

FIG. 1 shows a Computer Platform 100 for running simulations according to embodiments of the invention, including a Processor 102 and a computer readable Storage Medium 104 which may comprise a random access memory (RAM), a Compact-Disk Read-Only-Memory (CD-ROM), a Digital Video Disk (DVD) or other computer readable storage medium. The Storage Medium 104 includes computer readable instructions in the form of Computer Program Modules 106 stored thereon for execution by the Processor 102 to perform steps of methods described in more detail below. The Storage Medium 104 further includes a Data Space 108 for storing data structures and variables of the simulation. The Computer Program modules 106 and the Data Space 108 form a Simulation System 200 further shown in FIG. 2. The Computer Platform 100 may be a general purpose computer, or the Processor 102 may be implemented as a specialized processor.

The Computer Platform 100 further includes an Input-Output System 110 through which the Simulator System 100 can be operated, and may include a Display Device 112 for displaying simulation results.

Not shown in FIG. 1 are interconnecting busses and other devices which are also common in computer systems of various kinds that would be capable of realizing the Computer Platform 100 including real-time particle Simulator System 200, which may be implemented for example on a gaming console such as a Play Station® from Sony Computer Entertainment Inc., a tablet computer available from a number of suppliers, or an ordinary personal computer such as a Macintosh iMac® computer from Apple Inc. The Computer Platform 100 is however not limited to personal devices, and may also advantageously employ multiprocessor systems or multi-computer server systems, including network servers.

Embodiments of the invention are particularly well-suited for applications requiring a high level of computational efficiency. For instance, many particle simulation systems are required to run in real-time while using a small percentage of available system resources. Video games are one such application of the real-time particle simulator system 200. State-of-the-art video games incorporate a variety of particle system simulations in order to represent various elements of the game (e.g. explosions, rain, various magical effects). These simulations need to coexist with the game as a whole, meaning that they should use a minimum of system resources.

The visual quality of the simulation is defined by the perspective of a viewer situated at a point within the simulation, taking into account simulated obstructions and the fact that objects that are further away appear visually less distinct, and therefore require less detail. The general term for this phenomenon is Level of Detail (LOD), and a detailed explanation can be found in (Manocha, 2004). Embodiments of the invention take advantage of this phenomenon to reduce the number of particles, thus providing higher processing efficiency in the simulation, while maintaining high visual quality.

FIG. 2 shows a block diagram of a Real-time Particle Simulator System (Simulator System) 200 according to an embodiment of the invention that may be implemented on the Computer Platform 100 of FIG. 1, in the form of program code and data stored in the Storage Medium 104. The Simulator System 200 includes a Simulation Control Subsystem 202, a Particle Additions Module 204, Fitness Evaluator Module 206, a Pruning Setup Module 208, a Merge Cache 210, a set of Particle Operations Queues 212 including an Insertions Queue 214 and a Deletions Queue 216, a Merge Selection Module 218, a Particle Counter Module 220, a Pruning Module 222, a Particle Neighbours module 224, and a Current Particles Module 226. All modules of FIG. 2 comprise computer readable instructions or data stored in a computer readable storage medium for execution by the processor 102.

A real-time simulation is run by the Simulation Control Subsystem 202, including generating video frame time-steps, generating and updating simulated scenes in successive video frame time steps etc., using a variety of techniques which are common in particle simulations envisaged by the present invention. For example geometric and other parameter changes of particles that represent the simulated scene from frame to frame are controlled by the Simulation Control Subsystem 202, but are not further explained, as they are outside the scope of the present invention.

The modules and corresponding methods, which are embodiments of the invention are shown enclosed in a simulation optimization sub-system 228.

The Simulation Control Subsystem 202 also interacts with the Current Particles Module 226 which is a data structure for storing some or all of the particle elements of the simulation. Particles in the Current Particles Module 226 may include particles of various types such as vortex and ellipsoid particles which represent elements of the simulated scene. The number of particles in the Current Particles Module 226 is tracked in the Particle Counter 220.

The Simulation Control Subsystem 202 sets the parameter Pmax which may vary from frame to frame but remains constant during the processing of simulation optimization sub-system 228 in a given frame.

In addition to direct manipulations of the particles by the Simulation Control Subsystem 202, particles in the Current Particles Module 226 may be deleted, inserted, and manipulated (split or merged), by operations of the Pruning Module 222, as described generally in the following, and in more detail further below.

The Simulation Control Subsystem 202 may include particle emitters which generate new particles to the scene by delivering them to the Particle Additions Module 204.

In each frame, the Pruning Setup Module 208 determines operations to be performed, such as adding the new particles, deleting existing particles, merging particles, and splitting particles. Each individual particle operation is evaluated with a function in the Fitness Evaluator Module 206 to determine the visual quality impact of the operation. The Fitness Evaluator Module 206 may include different fitness evaluation functions corresponding to the different actions such as deletions, insertions, splits, and merges. All fitness evaluation functions should obey the same convention for reporting results in a common scale, ranging from positive to negative values corresponding to improved to degraded visual quality results from the operation.

The Fitness Evaluator Module 206 includes a Policy module in which constants governing options regarding the fitness evaluation functions are stored.

Each evaluated operation is then queued in one of the Particle Operations Queues 212. It is possible to define separate operations queues for each type of operation. But it is sufficient to use just two queues, the Insertions Queue 214 for queuing operations which result in an increase in the particle count, that is adding of the new particles and splitting of particles, and the Deletions Queue 216 for queuing operations which result in a decrease in the particle count, that is deleting existing particles and merging particles.

Once all operations are queued, a selected subset of the operations are then executed by the functions of the Pruning Module 222 which adds or removes particles from the set of Current Particles 226 as specified by the queued operation.

The fitness values of new particles and of existing particles govern the order in which the operations are executed by the Pruning Module 222. This could be achieved by sorting the Particle Operations Queues 212, but is more efficiently achieved by implementing the Particle Operations Queues 212 as priority queues, considering that only a small percentage of the particles may be subject to one of the operations by execution in the Pruning Module 222.

In a general sense, the Particle Operations Queues 212 is implemented in the form of a sorting module, in which the Insertions Queue 214 and the Deletions Queue 216 provide memory space, for example in the form of insertions and deletions arrays, for receiving the operations (operation record structures) from the Pruning Setup Module 208. The insertions and deletions arrays are then sorted according to fitness values by any of a number of known sorting algorithms, before being read by the Pruning Module 222 which then retrieves the operations in order of their fitness values. The equivalent implementation in the form of priority queues, i.e. the Insertions Queue 214 and the Deletions Queue 216, is preferred as being more efficient.

A priority queue is a commonly used data structure which supports enqueuing (“push”) and dequeuing (“pop”) of keyed records, where records may be enqueued in any order, but dequeuing results in records being retrieved in the order of their keys. It is also conveniently possible to inspect any record, specifically the “top” record in the priority queue without actually removing (“popping”) it. The “top” record is the record having the numerically highest key value in the queue.

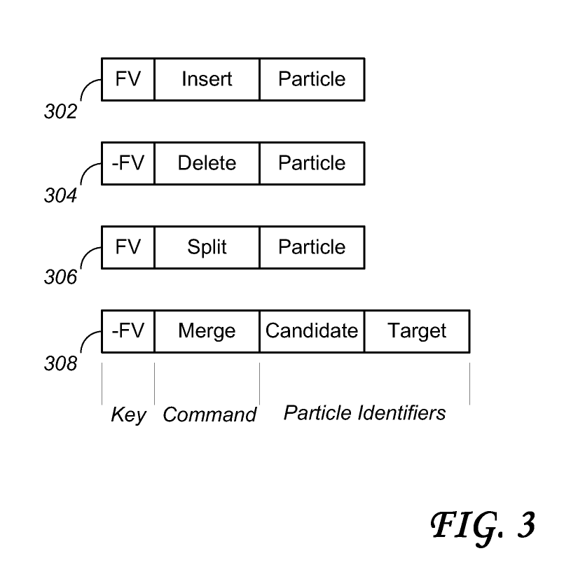

FIG. 3 shows examples of a format 300 of operations records for storage in the Particle Operations Queues 212, including formats of: an Insert Record 302, a Delete Record 304, a Split Record 306, and a Merge Record 308.

Each record includes a key which is derived from a numerical fitness value (FV) characterizing the net effect of the operation on visual quality, the magnitude of FV indicating the visual impact. By the aforementioned convention, a positive fitness value would indicate improvement, a negative value would indicate a reduction in the visual quality.

Because operations will be sorted in the operations queues by numerical key value, it is convenient to store operations in the Insertions Queue 214 with the fitness value as the key value, while operations which reduce the particle count are stored in the Deletions Queue 216 with the negated fitness value. This will result in the best (in terms of visual quality) operation in the Insertions Queue 214 to be located at the top, and so be the first to be retrieved for execution, i.e. insertion or splitting. Similarly, the worst (in terms of visual quality) operation in the Deletions Queue 216 will be located at the top, to so be the first to be retrieved for execution, i.e. deletion or merging.

Each record includes a command field carrying an operation code from the set {Insert, Delete, Split, Merge}. Additional (or composite) operations such as Fade and Warp could also be defined but are not essential. Fade would involve gradually changing the density of an ellipsoid particle over a number of frames when adding or removing it. Warp is defined as slowly changing the position and radius of a vortex particle.

Each record further includes fields identifying the particle(s) involved in the operation, e.g. in the form of pointers to the actual particle storage in the Current Particles 226 or the Particle Additions Module 204. For Insert and Delete records (302, 304), individual particles for insertion or deletion are identified. In one embodiment of the invention, only splitting into two particles, and merging of two particles is defined. For this purpose, the Split record 306 needs to indicate only the particle to be split, the resulting two split targets being implicit in the Split command. The Merge record 308 includes two particle identifiers, a merge candidate and a merge target. In an alternative implementation, only the merge candidate is identified in the Merge Record, the merge target being implicit as the particle that is nearest to the merge candidate, and can be retrieved from the Particle Neighbours Module 224 at the time when merging is actually executed.

Additional or alternative split and merge functions may be defined, such as n-way splits and n-way merges which require expanded formats to specify the number of particles involved.

Returning to the description of FIG. 2, the Pruning Module 222 operates in a sequence of three phases. In the first phase, operation records relating to the insertion of newly introduced particles (from the Particle Additions Module 204) are retrieved from the Insertion Queue 214 in the order from the best to the lowest fitness value. These are executed one at a time as long as the operation does not have a negative fitness value (which it should not, given these are new particles) or until the Particle Count reaches the predefined limit “Pmax”. In this phase, all newly introduced particles may already be inserted, i.e. added to the current particle set in the Current Particles Module 226, if the limit Pmax high enough.

In the second phase, any remaining newly introduced particles are inserted. But in order that the predefined limit “Pmax” is not exceeded, each insertion is balanced with a deletion or merge. For this purpose, Delete and Merge operations records are retrieved from the Deletions Queue 216, in the order of highest to lowest key associated with the respective operation. Because keys for fitness values are polarity inverted for operations in the Deletions Queue 216, the order from highest to lowest numerical value results in particles having the least visual impact being deleted first. The respective Delete or Merge commands are then executed, each operation resulting in reducing the particle count by one, assuming Merging is limited to two-way merging. The reason all new particles are inserted in order, starting with the “best”, as established in the Insertions Queue 216, is to cover the unlikely but not impossible case where more than Pmax new particles are available to be inserted, even after all previously existing particles are deleted.

In the third phase, the Pruning Module 222 optimizes the overall visual quality without exceeding the particle limit Pmax by drawing on both the Insertions Queue 214 and the Deletions Queue 216 to balance additional particle insertions (simple Inserts of any queued remaining new particles as well as splits) with particle removals (simple Delete actions and Merges) as long as the net fitness value of the combined actions is at least positive. The third phase is skipped if either the Insertions Queue 214 or the Deletions Queue 216 is empty.

As particle splitting is equivalent to the combination of a single deletion and two or more additions, each splitting operation results in a net increase in the particle count (220). Similarly, merging is equivalent to the combination of a single insertion and two or more deletions, hence the merging operation results in a net decrease in the particle count (220).

Merging may be performed on groups of two or more existing neighbouring particles which would be removed from the Current Particles Module 226 and combined into a single particle that is added back into the Current Particles Module 226. Neighbouring particles are identified in the Particle Neighbours Module 224, from which the Merge Selection Module 218 selects merge targets for merging. The selected merge targets may be stored in the Merge Cache Module 210 for efficiency.

The Particle Neighbours Module 224 is used to quickly identify neighbouring pairs or clusters of particles which are candidates for merging. In order to accomplish these searches efficiently, the Particle Neighbours Module 224 may include a data structure known as a KD-tree. KD-trees are one of a number of effective data structures for solving the “nearest neighbour” problem, a more detailed discussion of which can be found in “Nearest Neighbors in High-dimensional Spaces” by Indyk, P. in J. E. O'Rourke, Handbook of Discrete and Computational Geometry (2nd edition), CRC Press LLC.

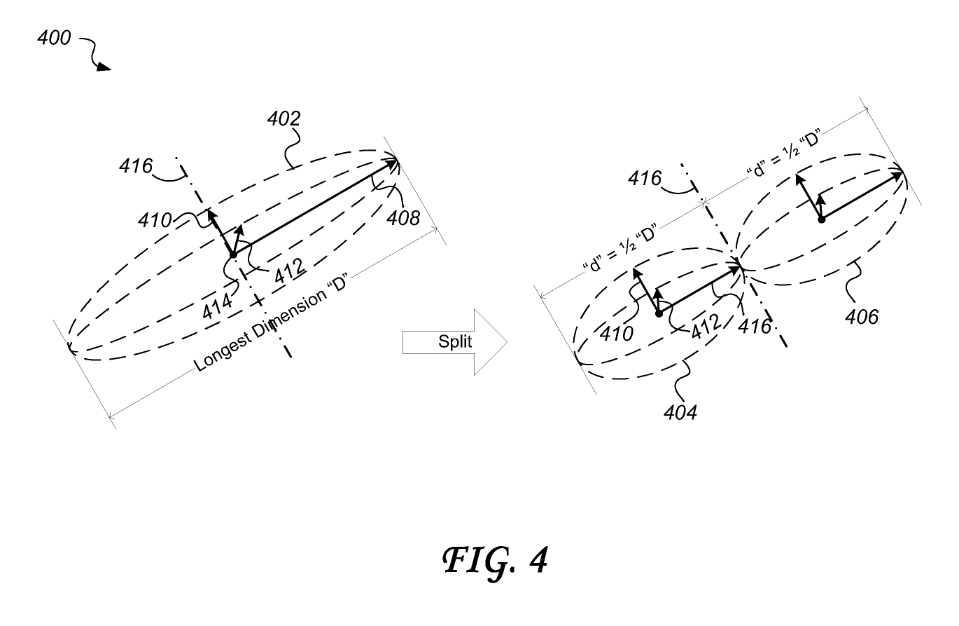

FIG. 4 illustrates an example of a splitting operation 400 according to an embodiment of the invention, showing a stretched 3-dimensional (3D) ellipsoid smoke particle 402, and a pair of smaller ellipsoid smoke particles 404 and 406 resulting from splitting the particle 402. The particle 402 is indicated by its boundary which is defined in three dimensions by three 3D vectors 408, 410, and 412. Reference numeral 414 indicates a 3D point representing the position of the particle 402 within a 3D simulation. The longest dimension of the particle 402 is indicated as a longest dimension “D”, along its longest axis, the 3D vector 408 in this illustration.

In the example illustrated, the particle 402 is split along a split line 416 into two identical fragment particles 404 and 406, where one axis 416 of the fragment particle 404 may be one half the length of the corresponding axis 408 of the original particle 402 while the other two axes (410 and 412) may remain unchanged. Thus, one dimension of each the particles 404 and 406 is now “d”=one half of the longest dimension “D” of the particle 402. The splitting policy shown in FIG. 4 is to split stretched particles in two, possibly four, fragments on the assumption that more compact particles will have a higher visual quality than stretched particles. This policy is expressed explicitly by a Split Fitness Function in the Fitness Evaluator Module 206.

For example, the following general split fitness function may used to determine the suitability of a given ellipsoid smoke particle “p” for splitting into “n” new particles:

proc SplitFitness(Particle p, Integer n):
Particle results=Array[n]
CalculateSplit(p, n, results)
Scalar cost=ParticleValue(p)
Scalar benefit=0
foreach (result in results):
   benefit+=ParticleValue(result)
return benefit−cost

The function “CalculateSplit(p, n, results)” calculates the split of the particle “p” into an array of “n” particles “results”, where “n” was determined by a splitting policy function which is not further described; “n”=2 in the present example.

The function “ParticleValue(p)” returns a fitness value reflecting for example the stretch ratio of the particle, scaled by the mass of the particle on the screen:

proc ParticleValue(Particle p):
Scalar mass=GetMass(p)
Scalar ratio=GetMinimumRadius(p)/GetEllipsoidRadius( )
return pow(mass, ImportanceOfLowParticleCount)*
   pow(ratio, ImportanceOfRoundness)

The “pow” function is the exponentiation function, the exponents being defined as constants in the Policy module:
ImportanceOfRoundness in the range of 0.25 to 4.0,
and
ImportanceOfLowParticleCount in the range of 0.25 to 4.0

The “GetMass” function is used to obtain the “mass” of the particle, mass being a function of the geometric volume of the particle and may include its density which is a function of its color.

Instead of using the “GetMass” function, one may also use a “GetScreenArea” function to obtain a measure of the screen area occupied by the particle, again optionally weighted by its density. The inventors have alternated between the two methods in their tests. The screen area measure (“GetScreenArea”) makes sense, especially in applications where the user changes their viewpoint of the smoke for example, such as is common in computer games. But where there is a lot of dynamic action, the mass measure (GetMass) generally works better.

The Policy module may be used to select the appropriate function, constant values, and other options in order to adapt the simulator to a particular application.

The constant “ImportanceOfRoundness” indicates the degree to which uniformly shaped points are desired, a higher value resulting in a higher particle value for a rounder (plumper) particle. A typical value of the constant “ImportanceOfRoundness” is 1.0.

The constant “ImportanceOfLowParticleCount” indicates the degree to which a low point count is desired, a higher value favoring large mass points over smaller mass points. A typical value of the constant “ImportanceOfLowParticleCount” is 1.0.

In the present example, a stretch ratio of 1:1 may yield a higher fitness value than a 1:2 or 2:1 stretch ratio, and both may yield higher fitness values than a 1:4 stretch ratio, depending on the choice of the constants determined in the policy. A particle with a smaller screen area yields a higher fitness value than a particle with a larger screen area.

As an example, the ellipsoid particle 402 of FIG. 4 may have a stretch ratio (ratio of the shortest to the longest axis) of 1:4 and a mass of 8 (arbitrary) units, yielding a particle value of 2.0 which is identified as “cost”. Split in two, i.e. the particles 404 and 406, each having a stretch ratio of 1:2 and a mass of 4 units (half of the particle 402), each would yield a particle value of 2.0, for a total “benefit” of 2*2.0=4.0. The resulting fitness value of the operation of splitting the particle 402 is then equal to the difference between “benefit” and “cost”, i.e. 4.0−4.0=12, which is a neutral outcome for this split.

It is noted that for calculating the fitness value of a split, the actual split may be deferred until the (smaller) split particles are actually added to, and the original (larger) particle is removed from, the Current Particles Module 226 by the Pruning Operations Module 222.

The process of merging two ellipsoid particles may be generally defined as constructing a new particle whose perimeter matches the combined perimeter of the original particles as closely as possible, and whose mass is equal to the combined particle masses. Fades would involve slowly changing the density of the particle, and splits would be used to break apart highly stretched or very large particles by bisecting them along their longest axis. More information on ellipsoid particles can be found in Angelidis, A., Neyret, F., Singh, K., & Nowrouzezahrai, D., A Controllable, Fast and Stable Basis for Vortex Based Smoke Simulation. ACM SIGGGRAPH Symposium on Computer Animation 2006.

A fitness function for the simple addition (insertion) of a particle could be based on the “ParticleValue(p)” above, which would return a higher positive fitness value for smaller, more globular particles. For simple deletions, the same fitness function would then favour deleting larger particles before smaller particles are deleted because of the reverse sorting effect of the Deletions Queue 216.

If one uses an accumulating continuous emitter for insertions, this ParticleValue evaluator can handle that as well. The accumulator will be continuous but it will determine emission by emitting a point, if that point is under the desired ParticleValue, it will hold onto that point and then after a period of time try to emit again but now that new point will have a larger mass value (as it is the integration of the continuous mass emission over a longer period of time.) The longer the accumulating emitter waits, the larger the ParticleValue of the emitted point, and thus it may pass the ParticleValue evaluator.

Other splitting or merging policies may be defined with other Fitness Functions provided, as well as other individual particle value functions. For example, the following is an alternative Split Fitness function which is based on evaluating only the particle to be split, without requiring to actually perform the split:

Proc getSplitWeight(Particle p)
Scalar minRadius=p.getEllipsoidMinimumRadius( )
Scalar maxRadius=p.getEllipsoidMaximumRadius( )
Scalar excessRadius=
   maxRadius−minRadius*cMinRatioForSplit
Scalar weight=(excessRadius>0) ? excessRadius: 0
return weight*p.getMass( )

The constant cMinRatioForSplit=2 defines the minimum ratio of max/min before a split is contemplated.

Similarly, a fitness function may be defined to assign a fitness value (a fade-out weight) to particles which may considered for deletion or fading out:

Proc getFadeOutWeight(Particle p)
Scalar minRadius=p.getEllipsoidMinimumRadius( )
Scalar fadeWeight=
   cFadeToSplitRatio*p.getMass( )*minRadius
return fadeWeight

The constant cFadeToSplitRatio defines if fades will be favoured over splits when set to 1 or higher, or whether splits will be favoured when it is set to less than 1.

With vortex particles accounting for the motion of smoke, ellipsoid particles are an elegant solution for simulating the appearance of smoke while retaining a low computational overhead. By stretching, splitting and deforming, ellipsoid smoke particles contribute greatly to the visual quality of the particle simulation, meaning only a small number are required to achieve convincing smoke effects. Ellipsoid particles include, at a minimum, a 3D point (414) representing their position, a scalar quantity representing density of the particle (not shown in FIG. 4), and three 3D vectors (408, 410, 412) representing major axes of the ellipsoid particle, which form an orthogonal basis of a 3D space.

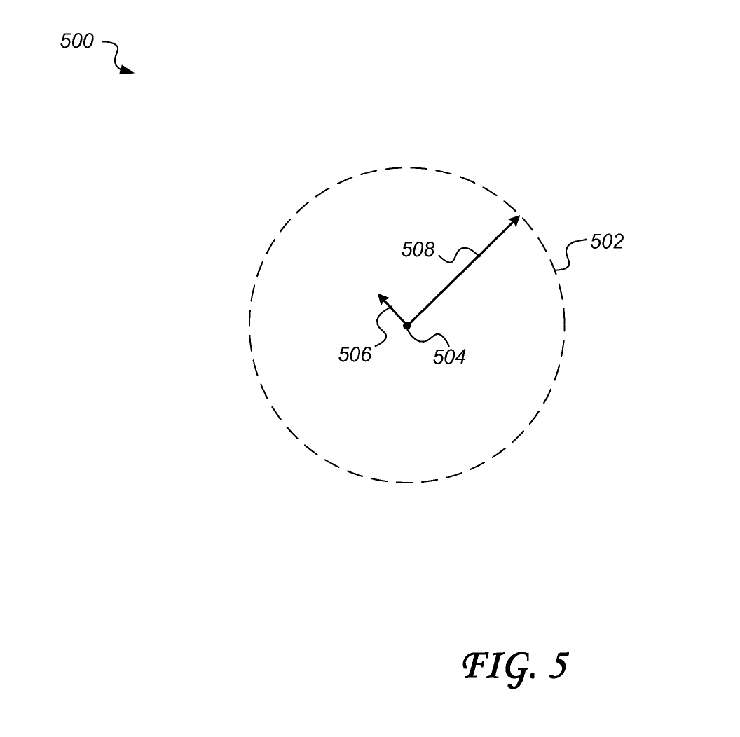

FIG. 5 shows a symbolic representation of a vortex particle 500, including a sphere of influence 502, a 3D point 504 representing the position of the vortex, a 3D vector 506 representing its curl, and another 3D vector 508 representing the radius of the sphere of influence 502.

Analogous insertion, deletion and merging actions may be defined for vortex particles. For example, merging of two vortex particles together may be achieved by constructing a new vortex whose angular momentum is equal to the sum of the angular momentums of the two original vortices. A vortex has a curl and a radius which together determine the speed and region of rotation. When merging two vortices together we want to maintain the same level of energy/momentum, thus we want to first determine the angular momentum of each individual vortex and then create a combined vortex that has the sum of the angular momentums of each of the individual vortices. The use of the term “angular momentum” is merely shorthand to refer to the fact that merged vortices should contain the same energy as the original vortices otherwise the system will either low or gain energy based on the number of merges, which would lead to undesirable visual artifacts—although if there was a choice, one should prefer equal or lesser energy for the sake of stability. Splitting of vortex particles has not been defined yet because no acceptably realistic result could be achieved in experiments conducted by the inventors. Fading vortex particles in or out may be defined as slowly increasing or decreasing the magnitude of the curl vector of the particle, and warping may be defined as slowly changing the position and radius of a vortex particle. More information on vortex particles can be found in Angelidis, A., & Neyret, F., Simulation of Smoke based on Vortex Filament Primitives, ACM SIGGRAPH Symposium on Computer Animation 2005.

While operations with ellipsoid particles are being described in detail in the present disclosure, it is understood that these operations equally apply to other types (classes) of particles including vortex particles. Particles of each class should not be mixed, and should be stored in separate sections of the Current Particles module 226, and processed by class specific methods of splitting and merging particles. As well, appropriate fitness evaluation functions in the Fitness Evaluators module 206 which are adapted to each class should be provided. But particles of all classes may be processed in the same way as ellipsoid particles in the following modules which essentially deal only with the quantity of particles and not their nature: the Particle Additions Module 204, the Pruning Setup Module 208, the Merge Cache 210, the Insertions Queue 214, the Deletions Queue 216, the Merge Selection Module 218, the Particle Counter Module 220, and the Pruning Module 222.

In summary, the insertion of newly created particles in areas of the simulation classified as “particle emitters” and available through the Particle Addition Additions 204, and the splitting of existent particles from the Current Particles Module 226 into two or more new particles, where such an action would measurably improve the quality of the simulation, are actions collected into the Insertions Queue 214 by functions of the Pruning Setup Module 208. In addition to these, arbitrary methods of particle insertion can be incorporated so long as appropriately conforming fitness functions can be defined on the new techniques.

Similarly, two types of removal action are generated in the Pruning Setup Module 208 and collected in the Deletions Queue 216: merging two or more particles whose combined effect on the simulation could be approximated by a single particle without giving a dramatic reduction in the simulation quality, and deleting particles whose contribution to the simulation quality is deemed low. The same constraint given for novel methods of insertion also applies here: other removal methods can be integrated into modifications of the embodiments of the invention so long as appropriate fitness functions are defined.

In the current embodiment, only two types of particle operations queues are created, one for accessing insertions (the Insertions Queue 214) and one for removals (the Deletions Queue 216). Optionally, separate queues may be created for each type of insertion or removal of particles, including any additional methods of insertion or removal.

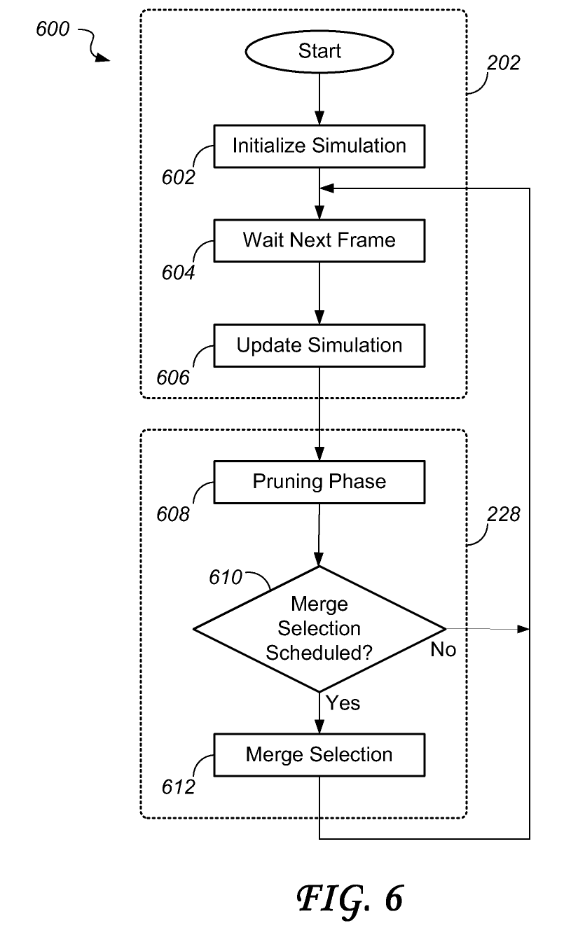

FIG. 6 is a simplified flow chart 600 of the method of operation of the Simulator System 200 of FIG. 2, including steps:
602: “Initialize Simulation”;
604: “Wait Next Frame”;
606: “Update Simulation”;
608: “Pruning Phase”;
610: “Is Merge Selection Scheduled?”; and
612: “Merge Selection”.

The steps 602 “Initialize Simulation”, 604 “Wait Next Frame”, and 606 “Update Simulation” are the responsibility of the Simulation Control Subsystem 202, and details of these steps are outside the scope of the present invention. In the step 602 “Initialize Simulation”, simulation parameters are initialized and dynamic software modules may be created. Then in the step 604 “Wait Next Frame” the next video frame is started. The actual simulation encompasses the steps 604 to 612 which are executed in a loop that runs once per (video) frame.

In the step 606 “Update Simulation”, simulation steps appropriate in a real-time simulation may be performed such as accepting user input, updating the locations and properties of simulation particles in the Current Particles Module 226, rendering visual scenes from the particles, etc. The step 606 “Update Simulation” may also include particle emitters which generate new particles intended for injection into the Current Particles Module 226, but which are held first in the Particle Additions Module 204 for processing in the following “Pruning Phase” step 604. The step 606 “Update Simulation” may also include updating other properties of the existing particles in the Current Particles Module 226, such as their intensity (fading) and shape and location (warping).

The Particle Counter 220 is continuously updated to reflect the actual number of particles in the Current Particles Module 226, and a value for Pmax is selected by the Simulation Control Subsystem 202 for each frame. Pmax may be selected as a means of allocating resources, given the available computing resources.

The steps 608 (Pruning Phase), 610 (Is Merge Selection Scheduled?), and 612 (Merge Selection) are embodiments of the invention which are executed in the simulation optimization sub-system 228 of FIG. 2.

In the step 608 “Pruning Phase” the particle count of the simulation is brought as close as possible to a desired value (i.e. the limit Pmax) without exceeding it, and the visual quality of the simulation is optimized by pairing insertions with appropriate sets of removals. The step 608 “Pruning Phase” comprises actions of the Pruning Setup Module 208 and the Pruning Operations Module 222, which employ fitness evaluator functions of the Fitness Evaluator Module 206 and make use of the Particle Operations Queues 212.

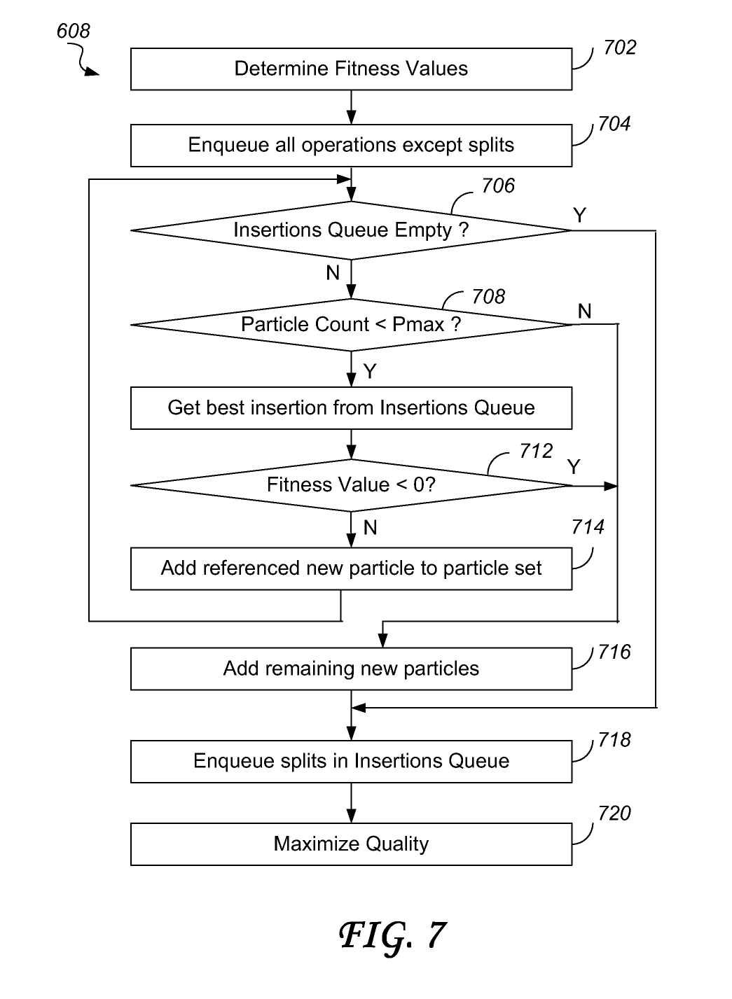

FIG. 7 is a more detailed flow chart of the “Pruning Phase” 608 of FIG. 6, including steps:
702: “Determine Fitness Values”;
704: “Enqueue all operations except splits”;
706: “Insertions Queue Empty ?”;
708: “Particle Count<Pmax”;
710: “Get best insertion from Insertions Queue”;
712: “Fitness Value<0?”;
714: “Add referenced new particle to particle set”;
716: “Add remaining new particles”;
718: “Enqueue split operations in Insertions Queue”; and
720: “Maximize Quality”.

In the step 702 “Determine Fitness Values”, the fitness values of all operations are determined, that is: the fitness values of all new particles waiting in the Particle Additions module 204 for insertion into the particle set of the Current Particles module 226; the fitness values of all existing particles in the particle set for potential deletion as well as for splitting; and the potential merge operations waiting in the Merge Cache 210.

In the step 704 “Enqueue all operations except splits”, the Insertions Queue 214 and the Deletions Queue 216 are cleared of operations records that may have been left from the previous frame. The Insert, Split, Delete, and Merge Records (ref 302, 304, 306, and 308 of FIG. 3) are generated with their corresponding fitness values and Particle or Target references. The Insert Records are enqueued in the Insertions Queue 214, and the Delete and Merge Records are enqueued in the Deletions Queue 216. The Split Records are enqueued in the Insertions Queue 214 later (step 718) so that the Insertions Queue 214 initially only contains new particles from the Particle Additions module 204 for adding into the particle set. Splits will be considered for inserting into the particle set only after the new particles have been dealt with.

The steps 706 to 714 form a loop in which operations for inserting new particles are removed (“popped” or “dequeued”) from the Insertions Queue 214 until either the limit Pmax for the particle count 220 is reached, or the Insertions Queue 214 is empty, and the new particles are transferred into the particle set. With each new particle transferred, the Particle Count (220) increases.

In the step 706 “Insertions Queue Empty ?” it is determined if the insertions queue is empty which would indicate that either all enqueued particles have already been dequeued and transferred into the particle set, or that no new particles had been generated at all. If the insertions queue is empty (exit “Y” from step 706), the loop (706-714) is exited and execution continues with the step 718, otherwise (exit “N” from step 706) execution continues with the following step 708.

In the step 708 “Particle Count<Pmax” it is determined if the particle count limit is almost reached. If the particle count is below the limit Pmax (exit “Y” from step 708), execution continues with the following step 710, otherwise (exit “N” from step 708) the loop (706-714) is exited and execution continues with the step 716.

In the step 710 “Get best insertion from Insertions Queue” the Insert Record with the highest fitness value, referencing one of the new particles, is popped from the Insertions Queue. The Insertions Queue (214, FIG. 2) is conveniently implemented as a priority queue as described earlier, and will automatically yield the operation with the highest fitness value. Not enqueuing Split Records until later ensures that the Insertions Queue can be first emptied of new particles before splits are considered, without the need to bypass split operations in the queue.

In the step 712 “Fitness Value<0?” it is determined if the fitness value of the presently dequeued Insert Record is negative, which preferably it should not be for new particles. However the step 712 allows for different fitness policies which may include negative fitness for new particles. If the dequeued Insert Record is negative (exit “Y” from step 712), the loop (706-714) is exited and execution continues with the step 716, otherwise (exit “N” from step 712) execution continues with the following step 714.

In the step 714 “Add referenced new particle to particle set”, the particle referenced in the Insert Record that was popped from the Insertion Queue in the step 710, is added to the particle set of the Current Particles module 226, and the Particle Counter 220 is incremented. After the step 714, the loop (706-714) continues with the step 706.

The step 716 “Add remaining new particles” is reached from step 708 only if the Insertions Queue is not (yet) empty, but the particle count has already reached the predefined limit of Pmax. In the present step 716, the remaining particles are added while simultaneously previously existing particles are removed or merged.

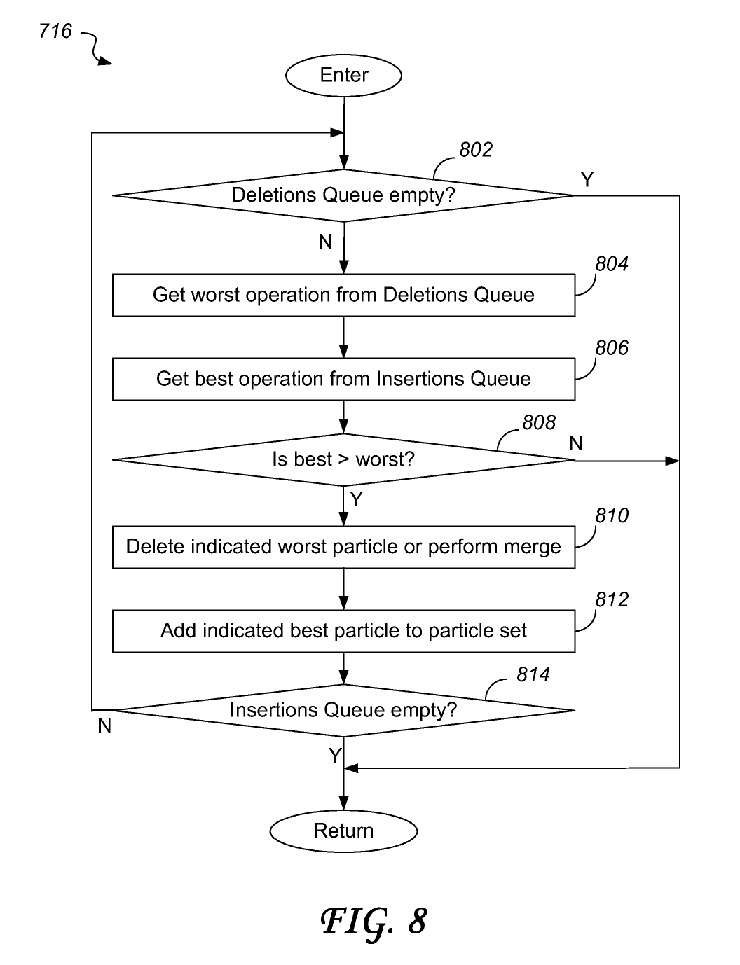

FIG. 8 is a more detailed flow chart of the step “Add Remaining New Particles” 716 of FIG. 7, including steps:
802: “Deletions Queue Empty?”;
804: “Get worst operation from Deletions Queue”;
806: “Get best operation from Insertions Queue”;
808: “Is best>worst?”;
810: “Delete indicated worst particle or perform merge”;
812: “Add indicated best particle to particle set”;
812: “Add indicated particle to particle set”; and
814: “Insertions Queue Empty?”.

The step “Add Remaining New Particles” 716 is expanded into a loop (802-814) in which each traversal of the loop pairs a deletion with an insertion of a new particle into the particle set of the Current Particles module 226, thus avoiding to exceed the particle count limit Pmax.

In the step 802 “Deletions Queue Empty?” it is determined if the deletions queue is empty which would indicate that there are no more particles in the particle set that can be deleted. If the insertions queue is empty (exit “Y” from step 802), the loop (802-814) is exited and execution returns to the next step in FIG. 7, otherwise (exit “N” from step 802) execution continues with the following step 804. If the deletions queue is empty at this point but the insertions queue is not, this would indicate that more than Pmax new particles are being introduced, for instance because Pmax was set too low. While this is not expected to happen often, the result would simply be that those new particles which have the lowest fitness value would not be inserted in the particle set.

In the step 804 “Get worst operation from Deletions Queue”, the “worst” operation is popped from the Deletions Queue 216, “worst” in the sense of having the lowest fitness value. The “worst” operation may be a Delete Record referencing a single particle to be deleted from the particle set, or a Merge Record which references a pair of particles to be merged. Either operation will reduce the particle count by one, thus making room for the subsequent insertion of a new particle. It is advantageous to store the fitness value keys in the Deletions Queue 216 with negative polarity, so that the arithmetically highest number represents the “worst”. In this way, the same priority queue routine can be employed for both the Insertions Queue 214 and the Deletions Queue 216.

The step 806 “Get best operation from Insertions Queue” is similar to the step 710 “Get best insertion from Insertions Queue” (FIG. 7) to pop the next Insert Record from the Insertions Queue 214, referencing a new particles with the highest or “best” fitness value.

In the step 808 “Is best>worst?”, the fitness value of the particle to be inserted (the best Insert Record popped in the step 806) is compared with the fitness value of the particle to be deleted or the merge fitness (the Delete Record popped in the step 804). Since delete keys are stored negatively, a simple addition of the keys of the two records will yield a net gain or loss in overall fitness. The objective of the step 716 is to increase the overall fitness within the constraints of not exceeding the particle count limit Pmax. Thus, if the comparison of the two operations results in a fitness gain (exit Y from the step 808), execution continues with the next step 810, otherwise (exit N from the step 808) there would be no gain, the “best” new particle would not be inserted, the loop (802-814) is exited and execution returns to the next step in FIG. 7.

In the step 810 “Delete indicated worst particle or perform merge”, the operation specified by the Delete or Merge record retrieved in the step 804 is executed on the particle set of the Current Particles module 226. This is either a simple deletion (removal) of the specified particle referenced in the Delete Record, or a merging of the particles referenced in the Merge Record.

In the step 812 “Add indicated best particle to particle set”, the particle referenced by the Insert Record retrieved in the step 806 is added to the particle set of the Current Particles module 226.

In summary, each successful execution of the steps 804 to 812 results in a “best” particle replacing a “worst” particle (or worst merge) in the particle set.

In the step 814 “Insertions Queue Empty?” it is determined if the insertions queue is empty which would indicate that all particles from the Insertions Queue have now been dequeued and added to the particle set. If the insertions queue is empty (exit “Y” from step 812), the loop (802-814) is exited and execution returns to the next step in FIG. 7, otherwise (exit “N” from step 812) the loop is restarted with the step 802.

The reader's attention is now directed to the continued description of FIG. 7.

After new particles have been added to the particle set of the Current Particles module 226, the Split Records generated in the earlier step 704, are enqueued in the step 718 “Enqueue splits in Insertions Queue”, into the Insertions Queue 214, in preparation for the next step in which the overall visual quality of the entire particle set is maximized.

In the step 720 “Maximize Quality”, visual quality is maximized by insertion operations and deletion operations of existing particles which are paired and executed as long as the net difference between their fitness values is positive.

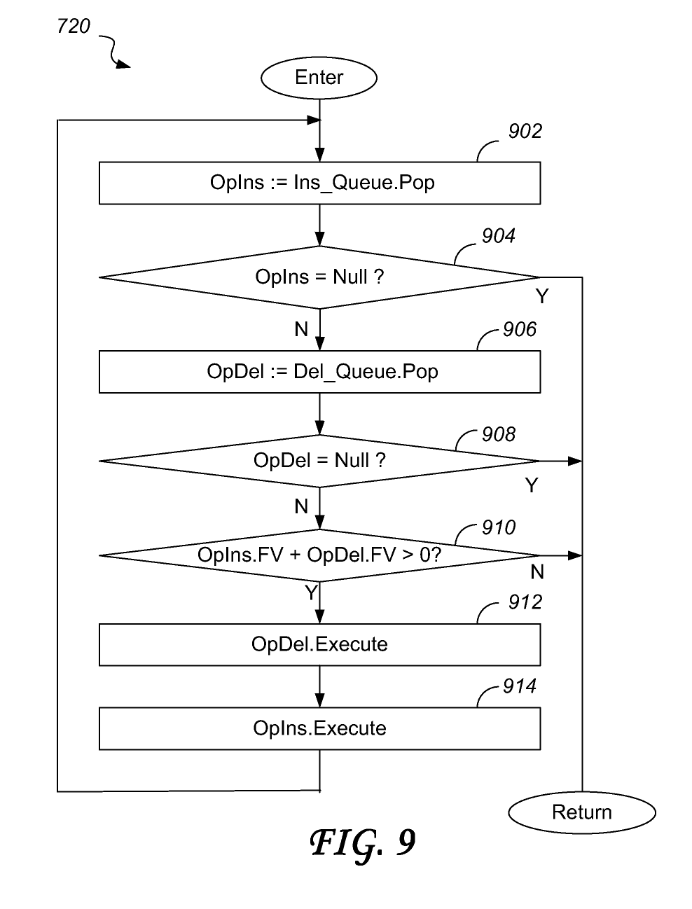

FIG. 9 is a more detailed flow chart of the step “Maximize Quality” 720 of FIG. 7, including steps:
902: “OpIns:=Ins_Queue.Pop”;
904: “OpIns=Null?”;
906: “OpDel:=Delns_Queue.Pop”;
908: “OpDel=Null?”;
910: “OpIns.FV+OpDel.FV>?”;
912: “OpDel.Execute”; and
914: “OpIns.Execute”.

The step “Maximize Quality” 720 comprises a sequence of steps in a loop (steps 902-914) which is entered at the first step 902 and runs until it exits as a result of either of the Operations Queue is empty, or because there is no more improvement in the visual quality to be obtained.

In the step 902 “OpIns:=Ins_Queue.Pop” the next insertion operation “OpIns”, is popped from the Insertions Queue 214. OpIns may technically be a simple Insert Record 302 (see FIG. 3) or a Split Record 306, but at this stage in the Pruning Phase 608, no new particles are available for insertion and OpIns will consequently be a Split Record referencing the splitting of a particle that provides the highest splitting fitness value of all splits still in the Insertions Queue 214. If the Insertions Queue 214 were empty at this point, popping it would retrieve a Null value.

The step 904 “OpIns=Null?” provides a way of determining whether the Insertions Queue 214 was already empty when popping of an insertion operations record was attempted in the previous step. If the insertions queue had been empty (exit “Y” from step 904), the loop (902-914) is exited and execution of the “Pruning Phase” step 608 is complete, otherwise (exit “N” from step 904) execution continues with the following step 906.

In the step 906 “OpDel:=Del_Queue.Pop” the next deletion operation “OpDel”, is popped from the Deletions Queue 216. OpDel may be a simple Delete Record 304 (see FIG. 3) or a Merge Record 308, one of which is the operation from the top of the Deletions Queue 216, i.e. the operation with the worst fitness value. If the Insertions Queue 214 were empty at this point, popping it would retrieve a Null value.

Like step 904 above, the step 908 “OpDel=Null?” provides a way of determining whether the Deletions Queue 216 was already empty when popping of a deletion operations record was attempted in the previous step. If the deletions queue had been empty (exit “Y” from step 908), the loop (902-914) is exited and execution returns to the next step in FIG. 7, otherwise (exit “N” from step 908) execution continues with the following step 910.

In the step 910 “OpIns.FV+OpDel.FV>?”, the fitness values “FV” of the two operations records retrieved in previous steps are compared. Because the polarity of fitness values in Delete and Merge Records from step 906 are negative, summing them with the fitness values from the Split Record from 902 corresponds to the net difference. If the difference is positive, this means that the visual quality improvement obtained with the split exceeds the deterioration from the deletion or merge (exit “Y” from step 910), and execution continues with the following step 912, otherwise (exit “N” from step 910) the loop (902-914) is exited and execution of the “Pruning Phase” step 608 is complete because no more improvement is available from operations still remaining in the queues.

In the step 912 “OpDel.Execute” the operation specified in the operations record OpDel, which may be a simple delete or a merge is executed which results in a reduction in the number of particles in the Current Particles module 226, thus making room for the increase in the particle count caused by the following step.

In the step 914 “OpIns.Execute” the operation specified in the operations record OpIns, which would usually be a split, is executed resulting in an increase in the number of particles in the Current Particles module 226, thus returning the particle count to the original number before the step 720.

The reader's attention is now directed to the continued description of FIG. 6.

Once the “Pruning Phase” step 608 has been completed, it is determined in the step 610 “Is Merge Selection Scheduled?” whether processing should continue (exit “Yes”) to the “Merge Selection” step 612 or (“N”) go on to the next frame, i.e. continue at the step 604 “Wait Next Frame”. Since merge selection is slightly more computationally expensive than pruning, the simulation may be configured, in view the available computing resources, that the merge selection step 612 will only be executed every k-th frame of the simulation. This still manages to guarantee the quality of the simulation, even if the cached merge targets are no longer appropriate after several frames without a merge selection step because the merging fitness function executed in the “Pruning Phase” step 608 will prevent any detrimental merges.

Alternatively, instead of running the merge selection step 612 only once every “k” frames, one could partition the particles into “k” fractions, each fraction containing approximately 1/k of all particles. One would then run the merge selection step 612 in a prescribed order on one of the “k” fractions so that each particle is updated (i.e. analyzed for a potential merge) exactly every “k” frames.

Optionally (not shown in FIG. 6), depending on the nature of the application, the pruning phase may also not necessarily be run in every frame.

In the “Merge Selection” step 612 prospective targets for removal by merging will be found. “merge target” is a term used to identify a particle which would be selected as the best candidate for merging with a given merge candidate. The “Merge Selection” step 612 is executed in the Merge Selection Module 218, by identifying, with input from the Particle Neighbours module 224, all or a sub-group of merge candidates and targets in the Current Particles 226, and storing them in the Merge Cache 210.

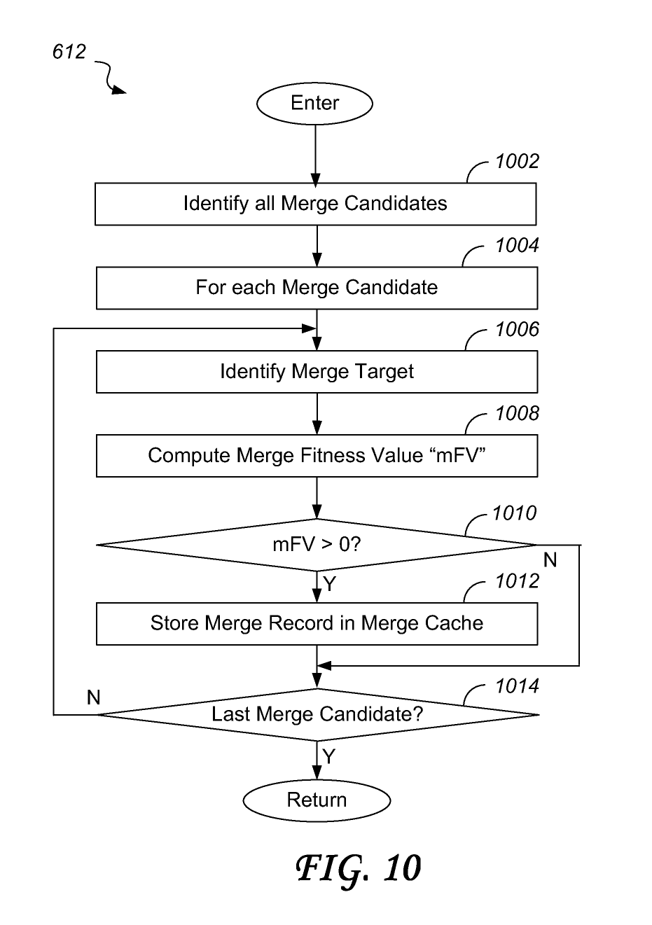

FIG. 10 is a more detailed flow chart of the “Merge Selection” step 612 of FIG. 6, including steps:
1002: “Identify all Merge Candidates”;
1004: “For each Merge Candidate”;
1006: “Identify Merge Target”;
1008: “Compute Merge Fitness Value “FV”;
1010: “FV>0 ?”;
1012: “Store Merge Record in Merge Cache”; and
1014: “Last Merge Candidate?”.

In the step 1002 “Identify all Merge Candidates”, a number of candidate particles are selected as merge candidates. Optionally, merge candidates could be flagged already during the Pruning Phase 608 based on some criteria, for example taking into account the fitness value of each particle. This could increase the efficiency of the merge selection step by decreasing the number of prospective merge candidates and the amount of computation required.

One may also only consider a portion of a particle set for each running of the “Merge Selection” step 612 to reduce the processing time of this step in a real-time simulation which has a limited time available in each simulation time-step that corresponds to a video frame period. This means one may spatially partition the particle set into subspaces and only consider the particles in one subspace in each frame. Thus the number of particles to be processed in one execution of the “Merge Selection” step 612 may be much less than the total number of particles.

In the step 1004 “For each Merge Candidate”, a loop (steps 1006-1014) is initialized for determining a merge target for each merge candidate, and analysing the suitability of the merge based on the fitness value this merge would have.

In the step 1006 “Identify Merge Target”, a current merge target is identified, the merge target preferably being a closest neighbour of the current merge candidate. The “Particle Neighbours” module 224 contains a data structure (for example a KD-Tree) which is efficient for identifying the closest neighbour particle. If several particles are equally close, one of these could be selected arbitrarily or at random. Alternatively (not shown in FIG. 10), the fitness of each possible merge with the several equally close neighbour particles could be evaluated, and the best selected.

In the step 1008 “Compute Merge Fitness Value “mFV”, the fitness value of merging the current merge candidate with the current merge target is computed in a “MergeFitness” function that is analogous to the “SplitFitness” function described earlier. To analyse a simple merging of two particles, i.e. candidate and target into a merged particle, the candidate and the target fitness values are subtracted from the fitness value of the merged particle. The resulting merge fitness value “mFV” is indicative of the improvement or reduction in the overall visual quality.

In the step 1010 “mFV>0 ?”, the suitability of the merge fitness value “mFV” is determined. In order to improve the visual quality as a result of the merge, a positive fitness value is desired. If “mFV” is positive (exit “Y” from step 1010), the current merge is favourable and execution continues with the next step 1012, otherwise (exit “N” from step 1010) the step 1012 is skipped and execution continues with the step 1014.

In the step 1012 “Store Merge Record in Merge Cache”, a Merge Record 308 with information specifying the current merge is stored in the Merge Cache 210 to be available for enqueuing in the Deletions Queue 216 during the “Pruning Phase” step 608 in a subsequent frame. Note that the sign of the fitness value in the Merge Record 308 should be inverted since merges are treated as deletions.

In the step 1014 “Last Merge Candidate?”, it is determined if the current merge candidate was the last candidate in the set of merge candidates for analysis. If so (exit “Y” from step 1014), the loop (1006-1014) terminates and the “Merge Selection” step 612 is finished, other wise (exit “N” from step 1014) execution continues with the step 1006.

When Merge Selection is run only every few frames, previously identified merge targets may have become stale, for example by deletion, splitting, or location change. Consequently stale merge targets are automatically removed or updated in the “Merge Selection” step 612 each time it is run.

### Multi-Way Splitting and Merging

The description of splitting and merging has been limited to 2-way splits and merges in the interest of simplifying the description, but it is understood that n-way splits and merges could easily be incorporated in the particle simulation.

For example a single split category, either a 3-way or a 5-way split per particle depending on the underlying geometry of the simulation, instead of the described simple 2-way split may be used. Alternatively, multiple split choices could be available for each particle, including dynamically choosing the split ratio in each simulation frame. If n-way splitting is used, the pairing of insertions which result from splitting with matching deletions, as described in the “Maximize Quality” step 720 above, would have to be modified so that if a single insertion (split) would create “n” new particles, “n” removals (deletions and 2-way merges) would have to be paired with this action. If there aren't enough elements available in the deletions queue to keep the particle count below the limit Pmax, then this optimization step (a modified step 720) would be stopped. As before, this set of actions would only be performed if a resulting overall fitness value, i.e. the sum of the fitness values of all these insertions and removals, indicates an overall improvement in the quality of the simulation.

Furthermore, multi-way merging where groups of more than two particles are merged may also be contemplated, resulting in additional straight forward extensions to the methods already described. Multi-way merging is also within the scope of the invention.

As a further optimization of the particle simulation process shown in FIG. 6, specifically the steps included in the simulation optimization sub-system 228, a random subset of particles could be chosen to operate on, instead of all particles within the simulation, in order to reduce the amount of processing resources used. Similarly, the particles of the simulation may be divided into groups, only one group being processed in each frame.

Notably, a single instance of the method of the embodiment of the present invention is capable of running on multiple particle simulations simultaneously. In this modification, “classes” of particles can be defined such that the merge selection step only operates between particles of a given class, while the pruning step takes into account all particles in all simulations. This prevents unrealistic or otherwise undesirable merges from occurring, while speeding up the execution of the method of the embodiments of the invention by only having to maintain one instance of the method and thereby eliminating a considerable amount of computational overhead. While this differentiation between particle classes is not optional to the operation of the present invention, it can yield a significant optimization in terms of processing resources consumed.

As an experiment, a working vortex-method CFD simulation of smoke particles was created and tested. An embodiment of the present invention was then implemented and applied to the particle system, taking into account some of the unique qualities of the simulation.

Two classes of particles were defined by the simulation, in order to properly and efficiently simulate the visual effect of wispy smoke: ellipsoid smoke particles, which encapsulate a volume of smoke; and vortex particles, which control the movement of all particles in the simulation.

With vortex particles (see FIG. 5) accounting for the motion of smoke, ellipsoid particles (see FIG. 4) are an elegant solution for simulating the appearance of smoke while retaining a low computational overhead. By stretching, splitting and deforming, ellipsoid smoke particles contribute greatly to the visual quality of the particle simulation, meaning only a small number are required to achieve convincing smoke effects.

To introduce particles into the simulation, regions of space inside the simulation were defined as particle emitters; both vortex particles and smoke particles could be introduced by each emitter.

In this simulation experiment, it was determined that merging vortex particles together would entail constructing a new vortex whose angular momentum was equal to the sum of the angular momentums of the two original vortices. Splitting vortex particles was omitted, as no acceptably realistic result could be achieved. Fading vortex particles in or out was defined as slowly increasing or decreasing the magnitude of the curl vector of the particle, and warping was defined as slowly changing the position and radius of a vortex particle.

Similarly, for ellipsoid particles, the process of merging two particles together was defined as constructing a new particle whose perimeter matched the combined perimeter of the original particles as closely as possible, and whose mass was equal to the combined particle masses. Fades would involve slowly changing the density of the particle, and splits would be used to break apart highly stretched or very large particles by bisecting them along their longest axis.

As a first step in producing an embodiment of the present invention, fitness functions as described above were defined for each of the aforementioned operations.

With the appropriate fitness functions defined, the Pruning Phase 608 was executed in which insertions and removals were considered on the basis of their fitness values, and carried out for both classes of particles. It was noted that the pruning phase provides a possible optimization to the process of particle emission. By modifying the fitness function for new particle insertions such that the simulation's velocity field which is defined by the vortex particles is taken into account, one can increase the cost of emitting new particles and decrease the initial velocity of emitted particles when the velocity near the emitter is low. This would reduce the number of new particles needed, and would increase the realism of the simulation by emulating the behaviour of real smoke. While this additional optimization opportunity has been recognized, however a detailed description of its implementation is omitted here.

After the Pruning Phase 608, it was determined in the step 610 (Is Merge Selection Scheduled?) whether the Merge Selection step 612 should be run on a cloud of particles by keeping track of the number of elapsed frames since each individual cloud of particles was updated. In the case of the simulation experiment, there were two particle clouds, a cloud of ellipsoid particles and a cloud of vortex particles. The Merge Selection step 612 was only performed on one particle cloud after 10 frames of the simulation, the other cloud being processed after another 10 frames.

Although the embodiments of the present invention have been described with regard to particle-based Computational Fluid Dynamics real-time simulation, it is understood that variations or modifications of the present embodiments may also relate to other systems or methods of particle simulation which would benefit by algorithmically imposed limits on the memory and computational resources it can consume.

Although the embodiments of the invention have been described in detail, it will be apparent to one skilled in the art that variations and modifications to the embodiments may be made within the scope of the following claims.

What is claimed is:

1. A method, performed by a processor, for simulating a scene containing particles in a particle set, the particles representing visual elements of the scene, the method comprising:
(a) determining and continuously updating a particle count of particles in the particle set;
(b) determining respective fitness values for particle count reducing operations, comprising deleting operations and merging operations, correspondingly deleting and merging existing particles in the particle set, the fitness value of each particle count reducing operation being indicative of an incremental impact of the operation on a visual quality of the scene;
(c) determining fitness values for particle count increasing operations, comprising inserting operations and splitting operations, correspondingly inserting new particles into the particle set and splitting selected existing particles into groups of two or more particles;
(d) performing particle count increasing operations, including inserting the new particles into the particle set provided the particle count remains below a predefined limit, according to the fitness values of the corresponding particle count increasing operations so as to improve the visual quality of the scene.

2. The method of claim 1, further comprising:
(e) provided the particle count has reached the predefined limit and there are available new particles:
(e1) performing an additional particle count increasing operation, including inserting a new particle into the particle set, the particle being selected according to the fitness value of the particle count increasing operation;
(e2) performing a particle count reducing operation, including deleting an existing particle or merging selected existing particles, the particles being selected according to the fitness values of the particle count reducing operation;
(e3) repeating the steps (e1) and (e2) until there are no more new particles.

3. The method of claim 2, wherein in the step (e1) the particle count increasing operations are performed in an order of their respective fitness values, and in the step (e2) the particle count reducing operations are performed in an opposite order.

4. The method of claim 4, wherein the order is one of the following:
from higher fitness values to lower fitness values; or
from lower fitness values to higher fitness values.

5. The method of claim 1, further comprising:
(f) maximising the visual quality of the scene, comprising:
(f1) performing a particle count reducing operation, including deleting an existing particle or merging selected existing particles, the particle being selected according to the fitness value of the particle count reducing operation;
(f2) performing a particle count increasing operation, including splitting an existing particle, the particle being selected according to the fitness value of the particle count increasing operation;
(f3) repeating the steps (f1) and (f2) as long as the visual quality of the scene is improved.

6. The method of claim 5, wherein in the step (f1) the particle count increasing operations are performed in an order of their respective fitness values, and in the step (f2) the particle count reducing operations are performed in an opposite order; and
wherein the order is one of the following:
from higher fitness values to lower fitness values; or
from lower fitness values to higher fitness values.

7. The method of claim 1, wherein the step (c) comprises:
generating a delete record for each delete operation, comprising a reference to one of the existing particles and a fitness value of the delete operation; and
generating a merge record for each merge operation, comprising a reference to a respective merge candidate particle and corresponding merge target particle and a fitness value of the merge operation.

8. The method of claim 1, wherein the step (d) comprises:
generating an insert record for each insert operation, comprising a reference to a new particle and a fitness value of the insert operation; and
generating a split record for each split operation, comprising a reference to an existing particle from the particle set and a fitness value of the split operation.

9. The method of claim 8, wherein:
the step of generating further comprises queuing the insert records in an insertions queue; and
the step of inserting the new particles comprises reading insert records from the insertions queue in the order of respective fitness values.

10. The method of claim 1, wherein the steps (a) to (d) are performed every k-th video frame, k>=1.

11. The method of claim 2, wherein the merging comprises:
selecting pairs of neighbouring particles and identifying particles of each selected pair as merge candidate and merge target particles;
generating a merge record for each selected pair, each merge record comprising a reference to the merge candidate and the merge target of the respective selected pair, and the fitness value of the merge operation; and
storing each merge record in a merge cache.

12. The method of claim 7, wherein:
the step of generating further comprises queuing the delete records in a deletions queue; and
the method further comprises obtaining selected merge records and storing them into the deletions queue.

13. The method of claim 1, wherein the fitness values for the particle count increasing or reducing operations depend on geometric volume or screen area, density and an aspect ratio of particles involved in the operation and resulting from the operation.

14. The method of claim 13, wherein the fitness value for the split operation is a function of a largest and smallest dimension of the particle to be split.

15. The method of claim 13, wherein:
the fitness value for the split operation is a difference between combined fitness values of two or more insert operations of particles resulting from the split, and the fitness value of the delete operation for deleting a particle to be split; and
the fitness value for the merge operation is a difference between the fitness value of the insertion operation for a particle resulting from the merge and combined fitness values of two or more deletion operations of particles being merged.

16. The method of claim 1, wherein the particles are ellipsoid particles.

17. The method of claim 1, wherein the particles are vortex particles.

18. A system for real-time particle simulation, comprising a general purpose or specialized processor and a computer readable storage medium having computer readable instructions for execution by the processor, forming:
a current particles module for storing a set of particles;
a pruning setup module for generating particle operation records to specify one or more of inserting, deleting, splitting and merging particles in the current particles module;
a fitness evaluator module for assigning, for each particle involved in one or more of inserting, deleting, splitting and merging operations, respective visual fitness values for each operation, and storing the assigned visual fitness values in the particle operation records;
two or more of particle operations queues for storing the particle operation records including their respective visual fitness values; and
a pruning operations module for retrieving the particle operation records from the particle operations queues in an order of their respective visual fitness values, and executing on the set of particles each particle operation indicated in the retrieved particle operation records.

19. The system of claim 18, further comprising a particles additions module for temporarily storing new particles injected into the simulation, the particles additions module being operatively coupled to the pruning setup module.

20. The system of claim 18, further comprising a particle counter for tracking the number of particles in the current particles module.

21. The system of claim 18, further comprising:
a particle neighbours module for determining nearest neighbours of particles in the set of particles;
a merge selection module for identifying, from the particle neighbours module, particles as merge candidates and merge targets; and
a merge cache for storing the merge candidates and merge targets, to be available to the pruning setup module.

22. The system of claim 20, wherein the set of particle operations queues comprises an insertions queue for storing particle operation records which have an effect of increasing the number of particles, including insert records and split records, and a deletions queue for storing particle operation records which have an effect of decreasing the number of particles, including delete records and merge records.

23. A method, performed by a processor, for real-time simulation of a scene containing particles in a particle set, representing visual elements of the scene, the method comprising:
reducing a particle count in the particle count reducing operation by deleting or merging selected existing particles in the particle set;
increasing the particle count in a particle count increasing operation by inserting new particles into the particle set or by splitting selected existing particles;
assigning a fitness value indicative of an impact on a visual quality of the scene to each of the particle count reducing operation and the particle count increasing operation; and
provided the fitness value assigned to an increasing operation is higher than the fitness value assigned to a reducing operation, performing the particle count increasing operation and the particle count reducing operation so that the total particle count is not increased and the visual quality of the scene is improved.
